(19) United States
(12) Patent Application Publication
(10) Pub. No.: US 2007/0077950 A1
(43) Pub. Date: Apr. 5, 2007

(54) Method and apparatus for adding contents to message in a mobile communication terminal

(75) Inventor: Shin-Hui Kang, Suwon-si (KR)

Correspondence Address: DILWORTH & BARRESE, LLP, 333 EARLE OVINGTON BLVD., SUITE 702, UNIONDALE, NY, 11553, US

(73) Assignee: SAMSUNG ELECTRONICS CO., LTD., Suwon-si (KR)

(21) Appl. No.: 11/542,847

(22) Filed: Oct. 4, 2006

(30) Foreign Application Priority Data
Oct. 4, 2005 (KR) 10-2005-0092943

(51) Int. Cl. H04Q 7/20

(52) U.S. Cl. 455/466; 455/550.1

(57) ABSTRACT

A method and an apparatus for adding contents to a message body in a mobile communication terminal is provided. When writing a message, a check is made whether a contents adding key is inputted. A contents box corresponding to the contents adding key is displayed, and a check is made whether contents to be added are selected from the displayed contents box. If the contents are selected, the selected contents are added to a body of the message.

### PRIORITY

This application claims priority under 35 U.S.C. § 119 to an application entitled “Method For Adding Contents To Message In A Mobile Communication Terminal” filed in the Korean Intellectual Property Office on Oct. 4, 2005 and assigned Serial No. 2005-92943, the contents of which are incorporated herein by reference.

### BACKGROUND OF THE INVENTION

1. Field of the Invention

The present invention relates to a method and an apparatus for adding contents when writing a message in a mobile communication terminal. In particular, the present invention relates to a method and an apparatus for giving an index to contents such as a sentence, a telephone number, multimedia contents, etc., and adding the index to a message when writing the message in a mobile communication terminal.

2. Description of the Related Art

Mobile communication terminals are widely used due to their convenient portability. Mobile communication terminal manufacturers are developing mobile communication terminals having more convenient functions.

For example, the mobile communication terminals provide various functions including, but not limited to, a phone book, a game, a short message, Internet access, e-mail, a morning or wake-up call, a MPEG Layer-3 and a digital camera.

In particular, a “short message” function has become a popular additional function in a mobile communication terminal. Young people tend to prefer a “short message” function to a call communication function. Also, the function of a short message is becoming more widely used to middle-aged and old-aged people as well.

As described above, along with increasing the use of the short message function, methods for inputting the message more conveniently are becoming studied.

There is a method of bringing a sentence from a sentence box which stores frequent input sentences and adding the sentence to a message body by using a connection menu. However, this needs many key manipulations to use a connection menu when adding the sentence to the message.

Also, there is a method of bringing a telephone number stored in a phone book to the end of a message by using a specific key operation (e.g., a method of pressing and holding a numeric key corresponding to an address storing a telephone number). However, the user must type a telephone number to add the telephone number to the message body.

### SUMMARY OF THE INVENTION

Accordingly, an object of the present invention is to provide a method and an apparatus for adding contents such as a sentence, a telephone number, multimedia contents, etc., to a message body by key mapping in a mobile communication terminal.

Another object of the present invention is to provide a method and an apparatus for giving an index to contents such as a sentence, a telephone number, multimedia contents, etc., and adding the contents to a message body by key mapping in a mobile communication terminal.

According to one aspect of the present invention for achieving the above objects, the method of adding a message to contents in a mobile communication terminal includes checking whether a contents adding key is inputted when writing a message. A contents box corresponding to the contents adding key is displayed, and a check is made whether contents to be added are selected from the displayed contents box. If the contents are selected, the selected contents are added to a body of the message.

### BRIEF DESCRIPTION OF THE DRAWINGS

The above and other objects, features, and advantages of the present invention will become more apparent from the following detailed description when taken in conjunction with the accompanying drawings in which:

FIG. 1 is a block diagram of mobile communication terminal according to the present invention;

FIG. 2 is a flow chart illustrating a procedure for updating contents in a contents box to be added to a message according to the present invention;

FIG. 3 is a flow chart illustrating a procedure for adding contents while writing a message according to the present invention;

FIGS. 4(A), (B), (C), (D) and (E) are illustrations depicting screen configurations for adding a sentence and a telephone number while writing a message according to the present invention; and

FIGS. 5(A), (B), (C), (D), (E) and (F) are illustrations depicting screen configurations for adding multimedia contents when writing a message according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail.

Hereinafter, a technology for giving an index to contents (e.g. a sentence, telephone number, multimedia contents, etc.) and adding the contents to a message body by simple key mapping in a mobile communication terminal is described. The message can include, but is not limited to, an SMS (Short Message Service) message, e-mail, an MMS (Multimedia Message System) message and an EMS (Enhanced Message Service). Also, the contents can include, but are not limited to, a sentence, a telephone number and multimedia contents.

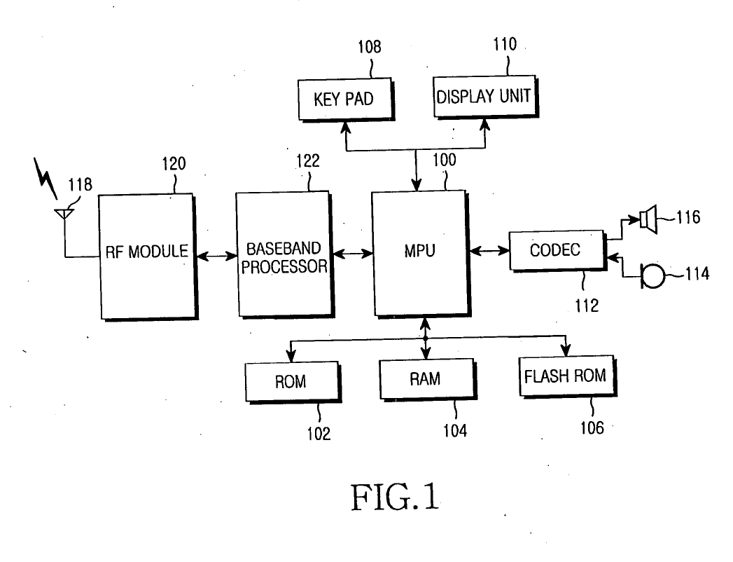

FIG. 1 is a block diagram of mobile communication terminal according to the present invention. The mobile communication terminal can include a cellular phone, a Personal Communication System (PCS), a Personal Data Assistant (PDA) or International Mobile Telecommunication-2000 (IMT2000).

Referring to FIG. 1, a Micro-Processor Unit (MPU), a controller, 100 controls an overall operation of the mobile communication terminal. For example, the MPU 100 is responsible for processing and controlling voice communication and data communication. In addition to the typical functions, the MPU 100 performs a function for giving an index to contents (e.g. multimedia contents, a sentence, a telephone number, etc.) and adding the contents to a message body by key mapping.

The Read Only Memory (ROM) 102 stores a microcode of software for processing and controlling the MPU 100 and all reference data. In particular, the ROM 102 stores software for adding the contents to a message body by key mapping. A Random Access Memory (RAM) 104, which is a working memory of the MPU, stores temporary data being generated while performing all programs. A flash ROM 106 stores various updatable data such as a phone book data, an outgoing message, an incoming message, etc. Further, the flash ROM 106 stores contents to be added to a message, such as a sentence, a telephone number, multimedia contents, etc.

A key pad 108 can include numeric keys of digits 0-9 and a plurality of function keys, such as a MENU key, a CANCEL (REMOVE) key, an ENTER key, a TALK key, an END key, an internet connection key, navigation keys (▴/▾/ [symbol] / [symbol] ), character input keys, etc. The key input data corresponding to a key pressed by the user is transmitted to the MPU 100. Further, a contents adding key is used for adding the contents to the message body by key mapping when writing a message. Also, the contents adding keys are set according to the contents. The contents adding keys may be keys not to be used to write a message or any key set by a user.

A display unit 110 can display status information, a restricted number of characters, moving pictures, still pictures, etc. The display unit 111 may be a color LCD (Liquid Crystal Display).

A Coder-Decoder (CODEC) 112 is connected to the MPU 100A microphone 114 and a speaker 116 are connected to the CODEC 112, and are audio input/output blocks for use in voice communication. The MPU 100 produces PCM (Pulse Code Modulation) data and the CODEC 112 converts the PCM data into analog audio signals. The analog audio signals are outputted through the speaker 116. Also, the CODEC 112 converts analog audio signals received through the microphone 114 into PCM data and provides the MPU 100 with the PCM data.

A Radio Frequency (RF) unit 120 drops a frequency of an RF signal received through an antenna 118 and provides the RF signal to a baseband processor 122. Also, the RF unit 120 increases a frequency of a baseband signal provided from the baseband processor 122, and transmits the baseband signal through the antenna 118. The baseband processor 122 processes the baseband signals which are transmitted/received between the RF unit 120 and the MPU 100. For example, in case of the data transmission, the baseband processor 122 performs channel coding and spreading transmitting data. In case of the data reception, the baseband processor 122 performs despreading and channel decoding for reception data.

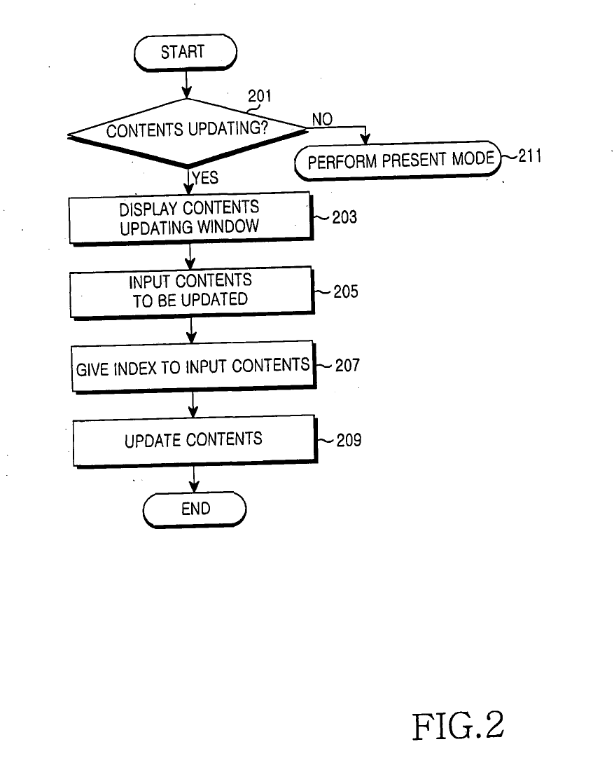

FIG. 2 is a flow chart illustrating a procedure for updating contents in a content box to be added to a message according to the present invention. The content box is in the flash ROM.

Referring to FIG. 2, the MPU 100 checks whether a contents updating menu is selected by a user's key manipulation in step 201. If the contents updating menu is not selected, the MPU 100 proceeds to step 211 to perform the present mode (e.g. a waiting mode or the like).

If the contents updating menu is selected, the MPU 100 proceeds to step 203 to display a contents updating window on the display unit 110. In step 205, the MPU 100 receives contents to be updated by the user's key manipulation. A user can input a sentence, a telephone number, multimedia contents, etc., by key manipulation or downloading via a wireless network.

If the contents to be updated are inputted, the MPU 100 proceeds to step 207 to give an index to the input contents. Here, the index performs a function such as ID (Identification) of the corresponding contents. Also, the index is given with or without distinction of contents types (e.g. a sentence, a telephone number, an image, music, etc.). For example, sentences can use index 0˜99 of the contents box, telephone numbers can use index 100˜199 of the contents box, images can use index 200˜299 of the contents box and music can use index 300˜399 of the contents box, thereby being distinguished according to each contents type.

Next, the MPU 100 proceeds to step 209 to update the contents and then the process ends.

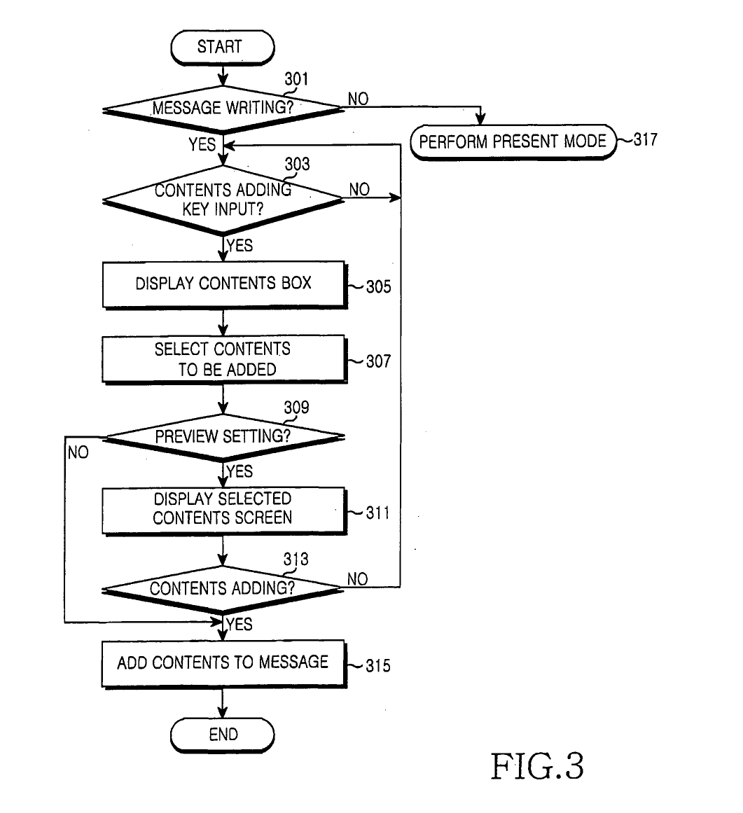

FIG. 3 is an illustration of showing a procedure for adding contents while writing a message according to the present invention.

Referring to FIG. 3, the MPU 100 checks whether a message writing menu is selected by a user's key manipulation in step 301. When the message writing menu is not selected, the MPU 100 proceeds to step 317 to perform the present mode (e.g. a waiting mode or the like).

If the message writing menu is selected, the MPU 100 proceeds to the step 303 to check whether a contents adding key is inputted by a user's key manipulation while writing a message. The contents adding key may be selected among keys not used while writing a message.

If the contents adding key is pressed for a predetermined time, the MPU 100 proceeds to step 305 to display the contents box on the display unit 110. Then, the MPU 100 proceeds to step 307 to check whether contents to be added are selected from the contents box by the user's key manipulation. Here, if an index number of the contents to be added is pressed during a predetermined period while the contents adding key is pressed, contents corresponding to the index number are selected.

Next, the MPU 100 proceeds to step 309 to check whether a preview function of the contents to be added is set. If the preview function is not set, the MPU 100 proceeds to step 315 to add the selected contents to a message body.

If the preview function is set, the MPU 100 proceeds to step 311 to display a screen showing the message including the selected contents. After this, the MPU 100 proceeds to step 313 to check whether a contents adding menu is selected by a user's manipulation. If the contents adding menu is not selected, the MPU 100 returns to step 303.

If the contents adding menu is selected, the MPU 100 proceeds to step 315 to add the selected contents to the message body, and then the process ends.

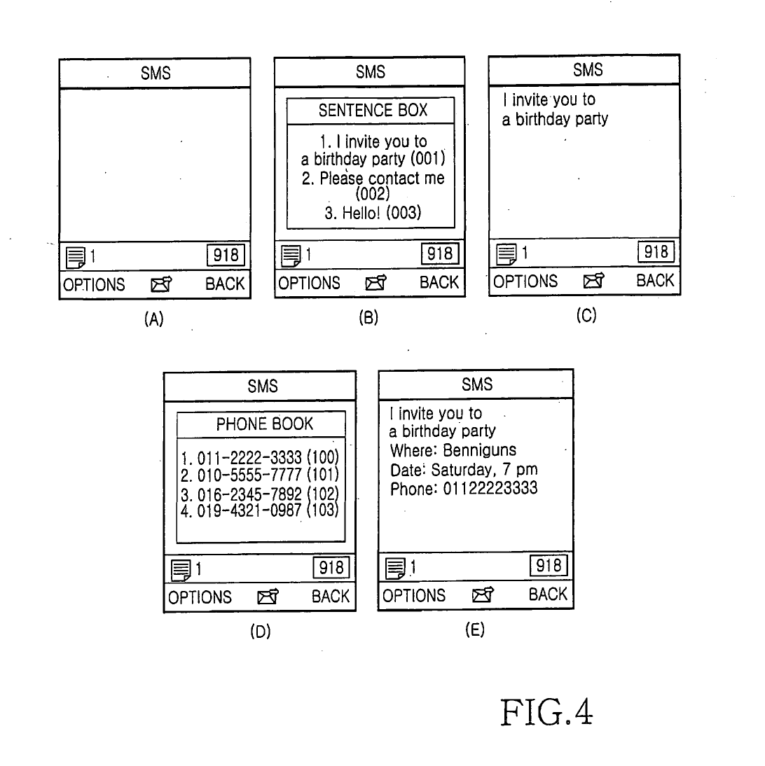

FIGS. 4(A), (B), (C), (D) and (E) are illustrations depicting screen configurations for adding a sentence and a telephone number while writing a message according to the present invention. Adding a sentence and a telephone number while writing an SMS message will be described. It is assumed that a sentence adding key is a side up key (▴) and a telephone adding key is a side down key (▾).

Referring to FIG. 4, if a side up key (▴) is inputted while writing an SMS message as shown in FIG. 4(A), a sentence box is displayed on the display unit 110 as shown in FIG. 4(B). Here, each of the sentences stored in the sentence box include a respective corresponding index. For example, the sentence “1. I invite you to a birthday party” has an index 001 and the sentence “2. Please contact me” has an index 002.

Next, if numeric keys of 001 are pressed and held for a predetermined time while the side up key is pressed, the sentence “I invite you to a birthday party” corresponding to the index 001 is added to the message body as illustrated in FIG. 4(C).

Meanwhile, if the side down key (▾) is inputted, a phone book is displayed on the display unit 110 as illustrated in FIG. 4(D). After this, if numeric keys of 100 are pressed and held for a predetermined time while the side down key is pressed, the phone number “011-222-3333” corresponding to the index 100 is added to the message body as illustrated in FIG. 4(E).

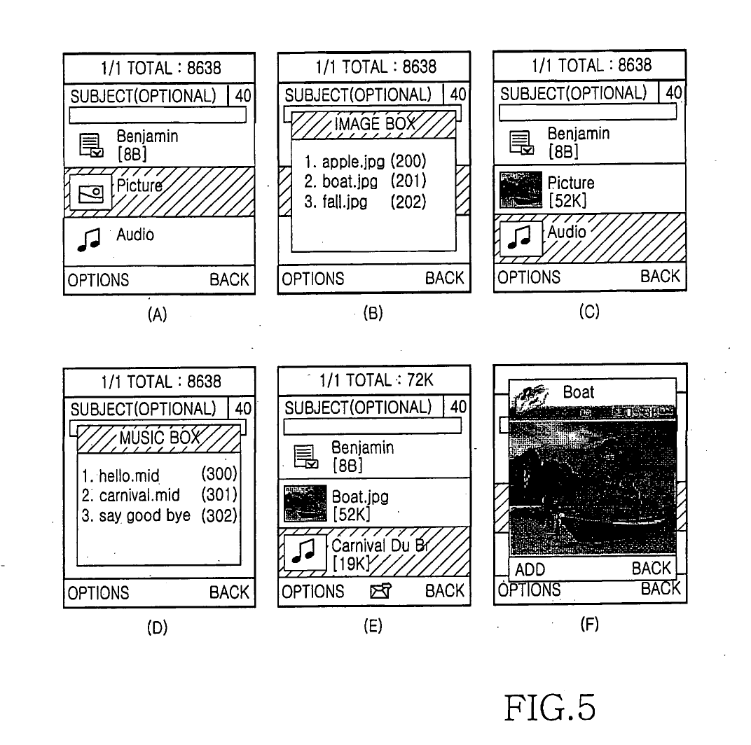

FIGS. 5(A), (B), (C), (D), (E) and (F) are illustrations of screen configurations for adding multimedia contents while writing a message according to the present invention. Adding an image and music while writing an SMS message will be described. It is assumed that an image adding key is a side up key (▴) and a music adding key is a side down key (▾).

Referring to FIG. 5, if a side up key is inputted while writing an MMS message as shown in FIG. 5(A), an image box is displayed on the display unit 110 as shown in FIG. 5(B). Then, if numeric keys of 201 are pressed and held for a predetermined time while the side up key is pressed, a boat image (boat.jpg) corresponding to the index 201 is added in the message body as shown in FIG. 5(C).

Meanwhile, if the side down key is inputted, a music box is displayed on the display unit 110 as illustrated in FIG. 5(D). After this, if numeric keys of 301 are pressed and held for a predetermined time while the side down key is pressed, carnival music (carnival.mid) corresponding to the index 301 is added to the message body as illustrated in FIG. 5(E).

In FIG. 5(F), if the boat image or the carnival music is added, a screen added the boat image or the carnival music is previewed so that a user can finally determine whether adding the boat image or the carnival music, or not.

As described above, the present invention provides a method and an apparatus for assigning an index to stored contents (e.g. a sentence, telephone number, multimedia contents, etc.) in the contents box and adding the stored contents to a message body by simple key mapping in a mobile communication terminal. A user can easily add the contents while writing a message.

While the present invention has been shown and described with reference to certain preferred embodiments thereof, it will be understood by those skilled in the art that various changes in form and details may be made therein without departing from the spirit and scope of the present invention as defined by the appended claims.

What is claimed is:

1. A method of adding contents to a message body in a mobile communication terminal, the method comprising the steps of:
initiating a contents adding key while writing a message;
displaying a contents box corresponding to the contents adding key;
selecting contents from the contents box; and
adding the selected contents to a body of the message.

2. The method of claim 1, further comprising including contents from at least one of a sentence, a telephone number, an image and music.

3. The method of claim 1, wherein the message includes one of an SMS (Short Message Service) message, email, an MMS (Multimedia Message System) message and an EMS (Enhanced Message Service).

4. The method of claim 1, wherein the contents adding key is different from the corresponding contents.

5. The method of claim 1, wherein the selecting contents step further comprises pressing a numeric key corresponding to an index of contents to be added for a predetermined time.

6. The method of claim 5, further comprising giving an index to each of the contents at random or by classifying according to kinds of the contents.

7. The method of claim 1, further comprising displaying a preview of the message including the selected contents when the contents are selected.

8. A method of adding contents to a message body in a mobile communication terminal, the method comprising the steps of:
checking whether a contents adding key is inputted while writing a message;
displaying a contents box corresponding to the contents adding key when the contents adding key is inputted;
checking whether contents to be added are selected from the contents box; and
adding the selected contents to a body of the message when the contents are selected.

9. The method of claim 8, further comprising including contents from any one of a sentence, a telephone number, an image and music.

10. The method of claim 8, further comprising selecting contents by pressing a numeric key corresponding to the index of contents to be added for a predetermined time.

11. The method of claim 10, further comprising giving an index to each of the contents at random or by classifying according to kinds of the contents.

12. The method of claim 8, further comprising displaying a preview of the message including the selected contents when the contents are selected before the step of adding the selected contents.

13. A mobile communication terminal for adding contents to a message body, the terminal comprising:
a contents adding key for initiating a contents adding function while writing a message;
a display unit for displaying a contents box corresponding to the contents adding key; and
a controller for selecting contents from the contents box and adding the selected contents to a message body.

14. The terminal of claim 13, wherein the contents include at least one of a sentence, a telephone number, an image and music.

15. The terminal of claim 13, wherein the contents adding key is different from the corresponding contents.

16. The terminal of claim 13, wherein a numeric key is pressed for selecting contents from the contents box corresponding to an index of contents to be added for a predetermined time.

17. The terminal of claim 16, wherein an index is given to each of the contents at random or by classifying according to kinds of the contents.

18. The terminal of claim 13, wherein the controller displays a preview of the message including the selected contents when the contents are selected before adding the selected contents to a message body.
